(19) United States
(12) Patent Application Publication
(10) Pub. No.: US 2026/0316704 A1
(43) Pub. Date: Oct. 15, 2026

(54) APPARATUS FOR VEHICLE POWER CONTROL AND METHOD FOR THE SAME

(71) Applicants: Hyundai Motor Company, Seoul (KR); Kia Corporation, Seoul (KR)

(72) Inventor: Bong Kyu CHOI, Hwaseong-Si (KR)

(21) Appl. No.: 19/409,929

(22) Filed: Dec. 5, 2025

(30) Foreign Application Priority Data
Apr. 10, 2025 (KR) 10-2025-0046951

(51) Int. Cl. B60R 16/033; B60R 21/017

(52) U.S. Cl. CPC B60R 16/033; B60R 21/017

(57) ABSTRACT

Disclosed are an apparatus for vehicle power control and a method for the same. The apparatus includes a battery provided in a vehicle, a communication interface provided in the vehicle, a plurality of controller circuits provided in the vehicle, to control a plurality of electronic circuits provided in the vehicle, respectively, and a power distributing controller circuit provided in the vehicle, to constantly receive power from the battery. The power distributing controller circuit supplies the power to the communication interface, supply the power to a first controller circuit, if receiving an address value of the first controller circuit, which his related to a request for starting a first service provided from the vehicle, and supply power to the plurality of controller circuits connected to the power distributing controller circuit, based on determining a driving intention for the vehicle as being present.

### CROSS-REFERENCE TO RELATED APPLICATION

This application claims the benefit of priority to Korean Patent Application No. 10-2025-0046951, filed in the Korean Intellectual Property Office on Apr. 10, 2025, the entire contents of which are incorporated herein by reference.

### TECHNICAL FIELD

The present disclosure relates to an apparatus for vehicle power control and a method for the same, and more particularly relates to a technology for vehicle power control for a vehicle-based service and for minimizing a dark current.

### BACKGROUND

The matters described in this Background section are only for enhancement of understanding of the background of the disclosure, and should not be taken as acknowledgment that they correspond to prior art already known to those skilled in the art.

A power supply system may include four states of “IGN OFF”, “ACC”, “IGN ON”, and “START” in total. The state of “IGN OFF” may be a state in which a vehicle is powered off. The state of “ACC” may be an accessory mode in which power is supplied to some electronic circuits in charge of convenience functions (a radio, wipers, a power window, a navigation system, and an air conditioner). The state of “IGN ON” may be a state in which power is supplied to all electronic circuits. The state of “START” may be a state in which power is supplied only electronic circuits necessary for engine cranking, or a state in which power is supplied to only electronic circuits necessary for the use of power in a higher voltage battery.

The four power states may be formed based on an internal combustion engine vehicle, and there may be various complexities in supplying power based on the characteristics of various types of vehicles.

For example, the state of “IGN” may be sub-divided into the states of “IGN1”, “IGN2”, and “IGN3” for operation, in which the state of “IGN1” is to supply power to all electronic circuits, the state of “IGN2” is a state for engine cranking (which is identical to the state of “START”), and the state of “IGN3” is a state to supply power to only an electronic circuit related to charging.

In addition, power may be supplied through a B+ line, and the electrical part may be configured to operate based on receiving signals through the IGN1, IGN2, and IGN3 lines, such that the electrical part remains a sleep state until activated. Accordingly, IGN1, IGN2, and IGN3 signals may be monitored.

In addition, in the sleep mode (power saving mode) of general electronic circuits, the power to a interface may be cut off except for power supplied to the memory, such that only minimal power is used, and execution of a service remains in a waiting state, thereby causing an unintentional power consumption.

The present disclosure introduces a technology which simplifies such a complex power state, configures a service-based power system suitable for software-defined vehicles (SDVs), and overcomes the limitations in the sleep mode.

### SUMMARY

The present disclosure has been made to solve the above-mentioned problems.

An example of the present disclosure provides an apparatus for a vehicle power control, capable of simplifying a complex power state inside a vehicle to efficiently use power inside the vehicle, and a method for the same.

The technical problems to be solved by the present disclosure are not limited to the aforementioned problems, and any other technical problems not mentioned herein will be clearly understood from the following description by those skilled in the art to which the present disclosure pertains.

According to the present disclosure, an apparatus of a vehicle may comprise a battery, a communication interface, a plurality of controller circuits configured to control a plurality of respective electronic circuits of the vehicle, and a power distributing controller circuit configured to receive power from the battery, supply the power to the communication interface, determine whether to supply the power to a first controller circuit of the plurality of controller circuits based on receiving an address value of the first controller circuit, wherein the address value is related to a request for starting a first vehicle operation of the vehicle, and based on a predicted driving operation for the vehicle, supply the power to the plurality of controller circuits.

The power distributing controller circuit may be configured to supply the power to the communication interface while no request for a vehicle operation is received from a user of the vehicle, and the communication interface may be in a waiting state for the request.

The power distributing controller circuit may be configured to disconnect the power supply to the plurality of controller circuits before the power is supplied to the communication interface to receive an address value of a controller circuit of the plurality of controller circuits, wherein the controller circuit is related to a request for starting a vehicle operation.

The power distributing controller circuit may be configured to, after the power is supplied to the first controller circuit, determine whether to cut off the power from the first controller circuit based on receiving, from the first controller circuit, a second address value of the first controller circuit, wherein the second address value is related to a request for terminating the first vehicle operation.

The power distributing controller circuit may be configured to, after the power is supplied to the first controller circuit, determine whether to cut off the power from the first controller circuit based on receiving a report from the first controller circuit, wherein the report indicates that the first controller circuit is in an idle state.

The power distributing controller circuit may be configured to, after supplying the power to the first controller circuit, determine whether to supply the power to a second controller circuit of the plurality of controller circuits based on receiving an address value of the second controller circuit, wherein the address value of the second controller circuit is related to a request for starting a second vehicle operation of the vehicle, and the power distributing controller circuit may be configured to control power supply to each controller circuit of the plurality of controller circuits via a respective switch of the controller circuit.

The power distributing controller circuit may be configured to, after supplying the power to the plurality of controller circuits, determine whether to maintain supply of the power to the second controller circuit based on receiving a request for terminating the second vehicle operation from the second controller circuit, wherein the second controller circuit is configured to control an electronic circuit of the vehicle related to safety during driving of the vehicle.

The power distributing controller circuit may be configured to supply the power to the plurality of controller circuits in one-to-one correspondence via respective switches.

The apparatus may further comprise an input interface, and the power distributing controller circuit may be configured to, after supplying the power to the communication interface, based on detecting boarding of a user in the vehicle, determine whether to supply the power to the input interface.

The power distributing controller circuit may be configured to receive, via the communication interface or the input interface, the address value of the first controller circuit.

According to the present disclosure, a method performed by an apparatus of a vehicle may comprise controlling, by a power distributing controller circuit of the vehicle, a communication interface of the vehicle, controlling, by a plurality of controller circuits of the vehicle, a plurality of respective electronic circuits of the vehicle, supplying power to the communication interface, determining whether to supply the power to a first controller circuit of the plurality of controller circuits based on receiving an address value of the first controller circuit, wherein the address value is related to a request for starting a first vehicle operation of the vehicle, and supplying the power to the plurality of controller circuits by connecting the power to the plurality of controller circuits to the power distributing controller circuit, based on a predicted driving operation for the vehicle.

According to the present disclosure, a vehicle may comprise a battery, a communication interface, a plurality of controller circuits, and a processor circuit configured to cause the vehicle to supply power from the battery to the communication interface in a waiting state in which a request for a vehicle operation is absent, receive, via the communication interface, an address value of a first controller circuit of the plurality of controller circuits, the address value being associated with a request for starting a first vehicle operation, supply, based on the received address value, power from the battery to the first controller circuit while restricting power supply to a second controller circuit of the plurality of controller circuits, based on a predicted vehicle start request, supply power from the battery to the plurality of controller circuits, and cut off power from the first controller circuit based on receiving from the first controller circuit at least one of a request for terminating the first vehicle operation or a report of an idle state.

The processor circuit may be configured to cause the vehicle to maintain power supply to a controller circuit associated with a safety-related service during driving of the vehicle, regardless of a received request to terminate the safety-related service.

The processor circuit may be configured to cause the vehicle to, based on detecting an abnormal operation of at least one of the plurality of controller circuits, cut off power to the at least one of the plurality of controller circuits to perform a hardware reset.

The processor circuit may be configured to cause the vehicle to supply power from the battery based on detecting an authenticated key in the vehicle.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of components in an apparatus for vehicle power control according to an example of the present disclosure;

FIG. 2 shows an example of a connection relationship of some components in an apparatus for vehicle power control according to an example of the present disclosure;

FIG. 3A shows an example of a state of cutting off the supply of power to controller circuits according to an example of the present disclosure;

FIG. 3B shows an example of a state of supplying power to only to a controller circuit, which is necessary for providing a service, among controller circuits according to an example of the present disclosure;

FIG. 3C shows an example of a state of supplying power to all controller circuits according to an example of the present disclosure;

FIG. 4 shows an example of a change in a service stack when starting a service, for each controller circuit according to an example of the present disclosure;

FIG. 5 shows an example of a change in a service stack when terminating a service for each controller circuit according to an example of the present disclosure;

FIG. 6 shows an example of a method for vehicle power control performed in an apparatus for vehicle power control according to an example of the present disclosure;

FIG. 7 shows an example of a method for vehicle power control performed in an apparatus for vehicle power control according to another example of the present disclosure;

FIG. 8 shows an example of a procedure of requesting for starting a vehicle service and performing the vehicle service according to an example of the present disclosure;

FIG. 9 shows an example of a procedure of requesting for the type of a vehicle service and stopping a service according to an example of the present disclosure; and

FIG. 10 shows an example of a computing system according to an example of the present disclosure.

### DETAILED DESCRIPTION

Hereinafter, some examples of the present disclosure will be described in detail with reference to accompanying drawings. When assigning reference numerals to components in each drawing, the same reference numerals will be assigned to the same components even though the elements are illustrated in different drawings. In addition, in the following description of an example of the present disclosure, a detailed description of well-known features or functions will be ruled out in order not to unnecessarily obscure the gist of the present disclosure.

In describing the components of the example according to the present disclosure, terms such as first, second, “A”, “B”, “(a)”, “(b)”, and the like may be used. These terms are merely intended to distinguish one component from another component, and the terms do not limit the nature, sequence or order of the constituent components. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a micro, a state machine, or the like. In some environments, the “processor” may refer to an application-specific integrated circuit (ASIC), a programmable logic interface (PLD), or a field-programmable gate array (FPGA), and the like. For example, the “processor” may refer to a combination of processing interfaces such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage interface, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware interface or multiple combined hardware interfaces, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing interfaces, programmable logic interfaces, field-programmable gate arrays, processors, controller circuits, microcontroller circuits, microprocessors, electronic interfaces, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

Vehicle operations may drive the application of the feature of service-based vehicle power management to reduce dark current, including at least one of autonomous driving control, sensor activation, braking control, acceleration control, or timing of driver alerts. For example, when a vehicle operation is required (e.g., enabling autonomous driving when all safety-related controller circuits are active, activating collision sensors for hazard detection, adjusting braking response during deceleration, limiting acceleration during stability control, or issuing driver alerts through communication circuits, etc.), power may be selectively supplied to the necessary controller circuits while non-essential circuits remain powered down to reduce or minimize standby drain.

One or more auxiliary interfaces (e.g., engine brake, exhaust brake, hydraulic retarder, electric retarder, or regenerative brake, etc.) may drive the application of the feature of service-based vehicle power management to reduce dark current. For example, when an auxiliary interface is required (e.g., activating a regenerative brake during deceleration, engaging an exhaust brake for downhill control, or applying an electric retarder for heavy-load conditions, etc.), power may be selectively maintained for that interface while non-essential circuits are powered down to minimize standby drain.

One or more communication interfaces (e.g., a modem, a network adapter, a radio transceiver, or an antenna, etc., capable of communicating via Ethernet, Wi-Fi, near-field communication (NFC), Bluetooth, Long-Term Evolution (LTE), 5G New Radio (NR), or vehicle-to-everything (V2X), etc.) may drive the application of the feature of service-based vehicle power management to reduce dark current. For example, when a communication interface is required for a specific function (e.g., enabling NFC for secure keyless entry, activating LTE or 5G for remote diagnostics, or powering V2X transceivers during driving for safety-critical signaling, etc.), power may be selectively supplied to that interface while non-essential interfaces remain powered down to minimize standby drain.

Minimum risk maneuver (MRM) operations may drive the feature of service-based vehicle power management to reduce dark current. During an MRM, power may be selectively maintained only for controller circuits necessary to complete the maneuver (e.g., braking, steering, or hazard signaling, etc.), while non-essential circuits are powered down to minimize standby drain. An MRM may be activated during autonomous driving when a driver does not respond to a takeover request, and one or more processors of the vehicle may control the driving operation for a set period of time (e.g., performing controlled deceleration, maintaining lane centering, or guiding the vehicle to a safe stop, etc.).

Biased driving operations may drive the application of the feature of service-based vehicle power management to reduce dark current. A driving control apparatus may perform biased driving by controlling the vehicle to maintain a lateral distance between the vehicle center and a reference point such as the center of a lane. For example, the vehicle may be controlled to remain within the lane but intentionally offset from its centerline. A biased target lateral distance may comprise an adjusted spacing that the vehicle aims to maintain from the lane center or another vehicle during maneuvers such as lane changes. When such biased driving control is required (e.g., shifting laterally to create a buffer from adjacent vehicles, adjusting spacing under wet or icy road conditions, or maintaining a safer offset from roadside obstacles, etc.), power may be selectively maintained for the controller circuits necessary to execute the maneuver while non-essential circuits remain powered down to minimize standby drain.

One or more sensors (e.g., IMU sensors, cameras, LiDAR, RADAR, blind spot monitoring sensors, lane departure warning sensors, parking sensors, light sensors, rain sensors, traction control sensors, anti-lock braking system sensors, tire pressure monitoring sensors, seatbelt sensors, airbag sensors, fuel sensors, emission sensors, throttle position sensors, or power electronics components such as inverters, converters, motor controller circuits, power distribution units, high-voltage wiring and connectors, auxiliary power modules, and charging interfaces, etc.) may drive the application of the feature of service-based vehicle power management to reduce dark current. When a sensor is required for operation control in autonomous or assisted driving (e.g., enabling RADAR and LiDAR for collision avoidance, activating tire pressure sensors during high-speed travel, using rain sensors to adjust wiper and headlight settings, or powering traction control sensors during slippery road conditions, etc.), power may be selectively supplied to that sensor while non-essential circuits remain powered down to minimize standby drain. Such sensor-driven operations may support various vehicle control functions (e.g., acceleration, deceleration, steering control, gear shifting control, braking system control, traction control, stability control, cruise control, lane keeping assist, collision avoidance, emergency brake assistance, traffic sign recognition, or adaptive headlight control, etc.).

An autonomous driving activation/deactivation operation may drive the application of the feature of service-based vehicle power management to reduce dark current. In particular, when autonomous driving is enabled, a vehicle power control apparatus may selectively supply or maintain power to the controller circuits needed for safe operation (e.g., perception sensors, braking and steering controller circuits, or communication modules, etc.), while non-essential circuits remain powered down to reduce standby drain. When autonomous driving is restricted (e.g., due to limited conditions or a driver takeover request, etc.), power may be maintained only for partially required functions while other circuits are cut off. When autonomous driving is deactivated (e.g., after driver intervention, system fault, or completion of a minimal risk maneuver, etc.), power may be reduced to a minimal set of circuits necessary for safety and monitoring, thereby minimizing dark current.

According to the present disclosure, a vehicle power control apparatus and method are provided to simplify complex vehicle power states and improve power efficiency. Vehicles may rely on multiple ignition states to distribute power, which often leads to unnecessary power consumption and issues such as dark current (e.g., background battery drain while the vehicle is off) when electronic interfaces remain partially active. To address this, the present disclosure introduces a power distributing controller circuit that continuously receives power from the vehicle battery and selectively supplies power to a communication interface and controller circuits within the vehicle. The power distributing controller circuit may initially supply power only to the communication interface in a waiting state, then supply power to one or more controller circuits upon receiving address values associated with requests to start specific services, and supply power to all relevant controller circuits when a driving intention is detected. Power may be cut off from controller circuits when services are terminated or idle states are reported, thereby reducing battery drain. By controlling power supply on a per-service basis and maintaining power only to safety-related controller circuits during driving, the present disclosure enables efficient use of vehicle power resources, reduces dark current, and provides robust, service-based power management suitable for modern software-defined vehicles.

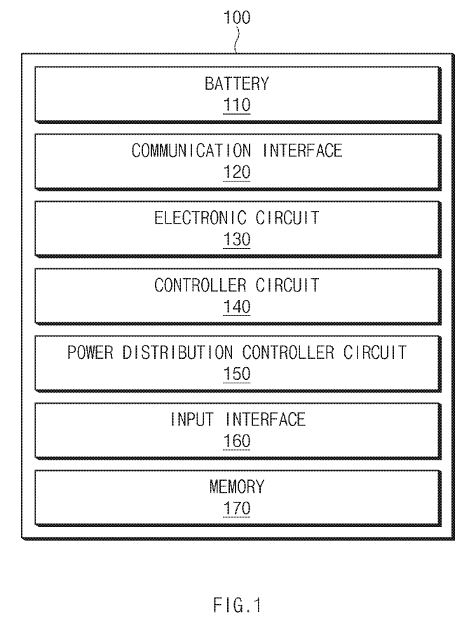

Hereinafter, examples of the present disclosure will be described with reference to FIGS. 1-10.

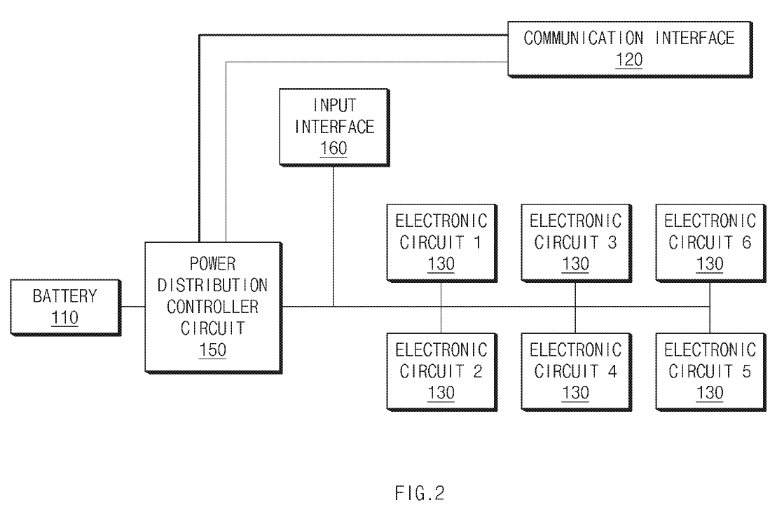

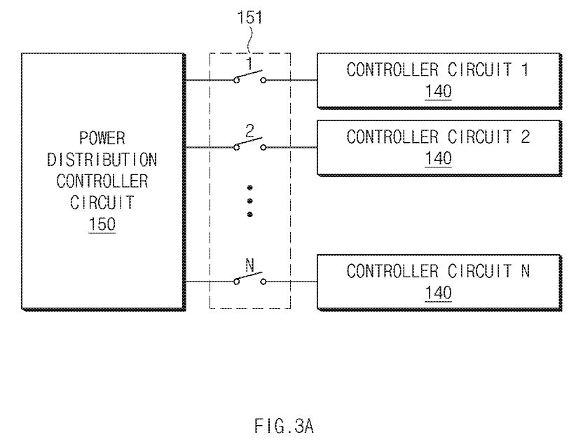

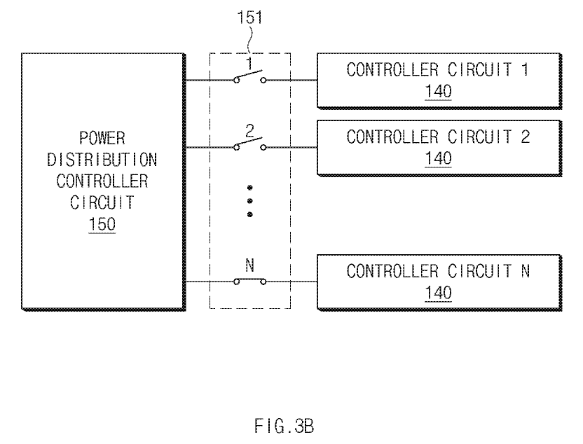

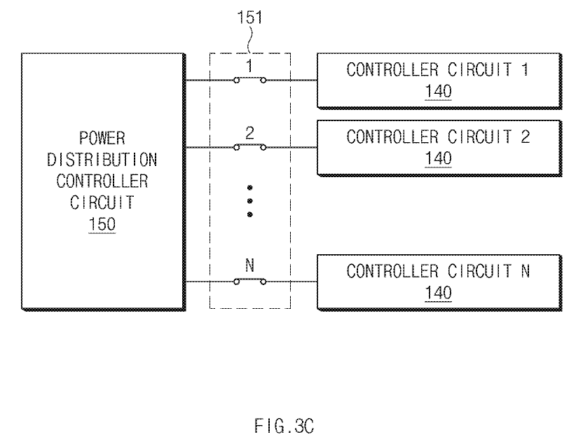

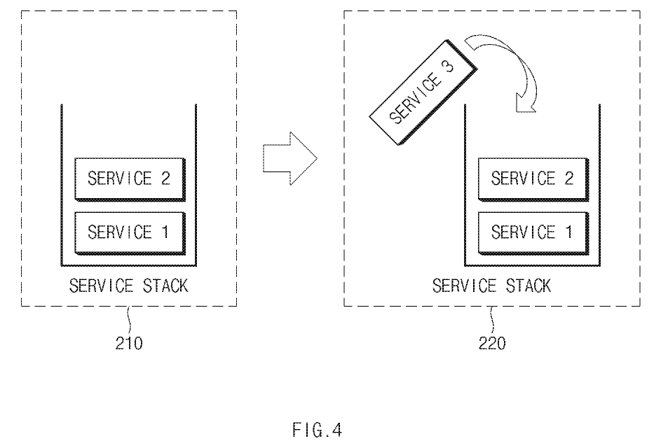

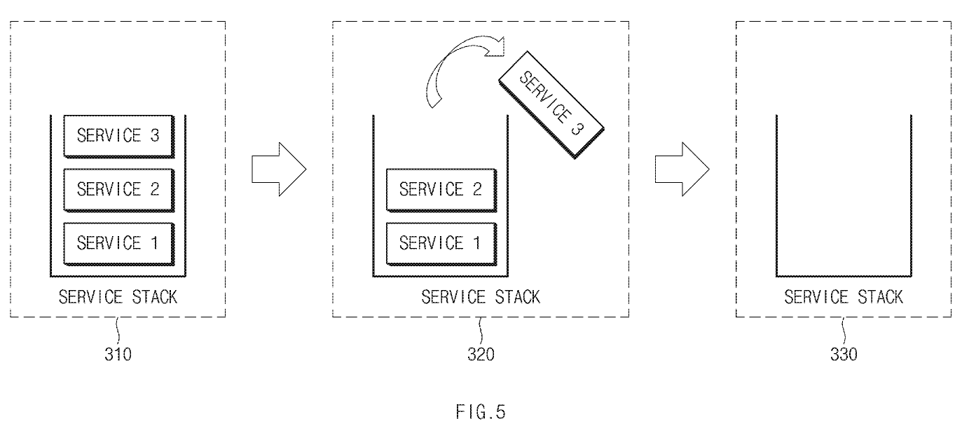

FIG. 1 shows an example of components in an apparatus for vehicle power control according to an example of the present disclosure. FIG. 2 shows an example of a connection relationship of some components in an apparatus for vehicle power control according to an example of the present disclosure. FIG. 3A shows an example of a state of cutting off the supply of power to controller circuits according to an example of the present disclosure. FIG. 3B shows an example of a state of supplying power to only to a controller circuit, which is necessary for providing a service, among controller circuits according to an example of the present disclosure, FIG. 3C shows an example of a state of supplying power to all controller circuits according to an example of the present disclosure. FIG. 4 shows an example of a change in a service stack when starting a service, for each controller circuit according to an example of the present disclosure. FIG. 5 shows an example of a change in a service stack when terminating a service for each controller circuit according to an example of the present disclosure.

Referring to FIGS. 1 and 2, an apparatus (hereinafter, vehicle power control apparatus) 100 for vehicle power control may be a computing interface allowing a computation. The vehicle power control apparatus 100 may be mounted on a robot, a vehicle, and/or a mobility interface (e.g., an electric scooter, a drone, a delivery robot, or an autonomous bus, etc.). For example, the vehicle power control apparatus 100 may be implemented inside the vehicle. In this case, the vehicle power control apparatus 100 may be formed integrally with internal control units of the vehicle or may be implemented separately from the internal control units of the vehicle to be connected with the internal control units of the vehicle so as to be connected through a separate connector (e.g., a wiring harness, a plug-in port, or a docking interface, etc.).

According to an example, the vehicle power control apparatus 100 may refer to a interface configured to control the power of interfaces inside the vehicle. For example, the vehicle power control apparatus 100 may be a interface to control states of supplying power to the vehicle in three phases (e.g., an initial standby phase, a partial service phase, or a full driving phase, etc.).

According to an example, the vehicle power control apparatus 100 may include a battery 110, a communication interface 120, an electronic circuit 130, an controller circuit 140, a power distributing controller circuit 150, an input interface 160, and a memory 170 (e.g., flash storage, volatile RAM, or non-volatile ROM, etc.).

According to an example, components in the vehicle power control apparatus 100 may be connected to each other through internal communication of the vehicle. An internal communication network of the vehicle may be implemented using at least one of communication technologies such as Ethernet, Controller circuit Area Network (CAN), Media Oriented Systems Transport (MOST) Network, Local Interconnect Network (LIN), or X-by-Wire (e.g., brake-by-wire, steer-by-wire, or shift-by-wire, etc.).

According to an example, the battery 110 may be provided in the vehicle, and may include a high-voltage battery and a low-voltage battery (e.g., a lithium-ion pack, a lead-acid battery, or a solid-state battery, etc.). For example, the battery 110 may provide at least one voltage of 12 V, 24 V or 48 V. According to an example, the battery 110 may provide power to the power distributing controller circuit 150.

According to an example, the communication interface 120 may be provided in the vehicle and may include an arbitrary type of wired or wireless communication network to transmit and receive an arbitrary type of data, information, and a signal (e.g., Wi-Fi, Bluetooth, cellular LTE/5G, or Ethernet, etc.). The communication interface 120 may support transmission and reception of the data, the information, and the signal to and from an external interface. The external interface may be, for example, a server to control a vehicle service (e.g., a remote fleet management server, a cloud diagnostic platform, or a navigation server, etc.).

According to an example, the communication interface 120 may receive a vehicle signal through data communication with the controller circuit 140, the power distributing controller circuit 150, and the input interface 160 in the vehicle. For example, the communication interface 120 may transmit data, information, and a signal received from the external interface to the power distributing controller circuit 150. As another example, the communication interface 120 may transmit data, information, and a signal that are received via the input interface 160, to the controller circuit 140 or the power distributing controller circuit 150 (e.g., user key fob detection, touchscreen commands, or biometric identification inputs, etc.).

According to an example, the electronic circuit 130 may refer to electric equipment and/or electronic equipment provided in the vehicle. For example, the electronic circuit 130 may include a motor, a black box, a central control unit, a sensor, a speaker, an audio system, a camera, a power interface, or an engine (e.g., a traction motor, a GPS sensor, a LiDAR scanner, or a battery management unit, etc.). At least one electronic circuit 130 or a plurality of electronic circuits 130 may be provided.

According to an example, the controller circuit 140, which is provided in the vehicle, may be an electronic control interface configured to independently control interfaces provided in the vehicle. For example, the controller circuit 140 may be an electronic control interface to control at least one of the battery 110, the communication interface 120, the electronic circuit 130, the input interface 160, or the memory 170 (e.g., managing battery charging, adjusting wireless communication settings, controlling infotainment, or handling sensor calibration, etc.).

According to an example, the controller circuit 140 may include at least one of an engine management system (EMS), a transmission control unit (TCU), a battery management system (BMS), or a fuse relay switch controller circuit (e.g., a brake control module, a lighting control unit, or an airbag control system, etc.).

According to an example, the controller circuit 140 may receive power in one-to-one correspondence via a switch 151 of the power distributing controller circuit 150. According to an example, a plurality of controller circuits 140 may be provided, and each controller circuit 140 may have an intrinsic address value. For example, each controller circuit 140 may have a two-digit hexadecimal address value. The two-digit hexadecimal address value may represent a total of 255 controller circuit addresses, and the number of digits may increase if necessary (e.g., three-digit or four-digit hexadecimal address values for larger networks, etc.). For example, the addresses may be expressed in the form of controller circuit 1 (0x01), controller circuit 2 (0x02), controller circuit 3 (0x03), and controller circuit N (0x0N). In this case, ‘N’ may have a two-digit value, if ‘N’ has a value exceeding 15 (e.g., 0x10, 0x11, or higher values, etc.).

According to an example, the power distributing controller circuit 150 may include a control unit to perform an operation related to processing data of a central processing unit (CPU), a general purpose graphics processing unit (GPGPU), or a tensor processing unit (TPU) of the vehicle power control apparatus 100. The power distributing controller circuit 150 may include a micro controller circuit unit (MCU) (e.g., an ARM-based MCU, an automotive-grade MCU, or a real-time controller circuit, etc.).

The power distributing controller circuit 150 may typically control the overall operation of the vehicle power control apparatus 100. For example, the power distributing controller circuit 150 may distribute power to components in the vehicle power control apparatus 100 (e.g., supplying power selectively to sensors, activating entertainment systems, or powering drivetrain controller circuits, etc.).

The power distributing controller circuit 150 may provide information or a function suitable for a user or may process the information or the function, by processing a signal, data, or information input or output through the components included in the vehicle power control apparatus 100 or by running an application program (e.g., executing diagnostic software, managing over-the-air (OTA) updates, or processing voice command inputs, etc.) stored in the memory 170.

The power distributing controller circuit 150 may recognize the approach of a user (for example, a driver). For example, the power distributing controller circuit 150 may recognize the approach of the user by determining an authenticated key of the vehicle and a position of the key which is obtained through the wireless communication via the communication interface 120 (e.g., Bluetooth Low Energy key fob, smartphone digital key, RFID card, or ultra-wideband (UWB) tag, etc.).

The power distributing controller circuit 150 may recognize the boarding of the user in the vehicle. For example, the power distributing controller circuit 150 may recognize the boarding of the user, based on whether a sensing operation is performed via a seating sensor provided in a vehicle seat or on whether the authenticated key is present in the vehicle. The power distributing controller circuit 150 may recognize the boarding of the user, if the sensing operation is performed via the seating sensor, and if the authenticated key is present inside the vehicle (e.g., pressure sensor in the seat, infrared occupancy sensor, or seatbelt latch sensor, etc.).

According to an example, the power distributing controller circuit 150 may constantly receive power from the battery 110 (e.g., to maintain a standby state, to support over-the-air updates, or to keep anti-theft modules active, etc.).

According to an example, the power distributing controller circuit 150 may supply power to the plurality of controller circuit 140 in one-to-one correspondence via the switches (e.g., switches for a transmission controller circuit, a lighting controller circuit, a battery management controller circuit, or a climate control controller circuit, etc.).

According to an example, the power distributing controller circuit 150 may control states of supplying power to the vehicle in three phases, thereby reducing standby power consumption (e.g., only powering minimal circuits in phase one, powering selected service circuits in phase two, or powering all safety-critical circuits in phase three, etc.).

According to an example, the power distributing controller circuit 150 may supply power to the communication interface 120 in a first phase. The power distributing controller circuit 150 supplies power to the communication interface 120, in a state in which a request for a service is not received from a user of the vehicle, or a state of waiting for the request for the service (e.g., waiting for a remote unlock request, a pre-conditioning command, or a navigation data download, etc.).

According to the present disclosure, the service may refer to a service provided via the vehicle (e.g., climate control, media streaming, remote engine start, battery charging control, or autonomous driving assistance, etc.). The analysis and the definition of the controller circuit 140 may be previously performed in relation to providing the service, and may be previously stored in the memory 170.

The power distributing controller circuit 150 may not supply power to the plurality of controller circuits 140, before supplying the power to the communication interface to receive an address value of the controller circuit 140, which is related to a request for starting the service (e.g., infotainment startup, navigation activation, or remote cabin pre-heating, etc.).

Referring to FIG. 3A, the power is consumed only in the power distributing controller circuit 150 and the communication interface 120 in the first phase. All first to N-th switches 151 of the power distributing controller circuit 150 may be turned off, such that power is not supplied to any controller circuit 140 inside the vehicle (e.g., preventing standby drain from entertainment systems, preventing unnecessary activation of drivetrain controller circuits, or shutting off auxiliary modules, etc.).

According to an example, the power distributing controller circuit 150 may supply the power to the input interface 160, if detecting the boarding of the user in the vehicle, after the power is supplied to the communication interface 120 (e.g., touchscreen activation, steering wheel button circuits, or biometric authentication panel, etc.).

According to an example, the power distributing controller circuit 150 may receive an address value of the first controller circuit, which is related to a request for starting a first service, via the communication interface 120 or the input interface 160 (e.g., address transmitted through a telematics modem, a key fob receiver, or a voice-command processing unit, etc.).

According to an example, the power distributing controller circuit 150 may supply the power to the first controller circuit, if receiving the address value of the first controller circuit, which is related to the request for starting the first service provided from the vehicle, in a second phase (e.g., powering only the infotainment controller circuit for media playback, enabling the battery charging controller circuit for scheduled charging, or activating the HVAC controller circuit for remote pre-conditioning, etc.).

Referring to FIG. 3B, the second phase may be a phase for supplying power, if a user intends to a service provided from a specific vehicle, except for a request for a service during driving. The power distributing controller circuit 150 may supply the power to only the N-th controller circuit 140 by turning on only a switch for the N-th controller circuit 140, which corresponds to the service provided from the specific vehicle, among all the first to N-th switches 151 of the power distributing controller circuit 150 (e.g., powering only the infotainment controller circuit for media playback, activating the HVAC controller circuit for remote cabin heating or cooling, or enabling the battery charging controller circuit for scheduled charging, etc.).

In the second phase, all switches 151 of the power distributing controller circuit 150 may not be simultaneously turned on. The transition to a third phase may be performed, if all switches 151 are turned on in the second phase (e.g., when the vehicle transitions from partial service mode to full driving mode, etc.).

According to an example, the power distributing controller circuit 150 may cut off the power from the first controller circuit, if receiving an address value of the first controller circuit, which is related to a request for terminating the service, from the first controller circuit, after the power is supplied to the first controller circuit. For example, if the service provided from the vehicle and requested by the user is terminated (for example, the service is terminated by the user or under a specific condition), the controller circuits for services may transmit information related to terminating the service to the power distributing controller circuit 150. The power distributing controller circuit 150, which receives the information, may turn off the switch for the controller circuit which notifies the termination of the service, after waiting for a specific time (e.g., shutting down a media player after playback stops, powering down a seat-massage controller circuit when the feature ends, or deactivating a navigation unit after a trip ends, etc.).

According to an example, the power distributing controller circuit 150 may cut off the power from the first controller circuit, if receiving a report of the idle state of the first controller circuit, from the first controller circuit, after the power is supplied to the first controller circuit. The idle state may mean that a service to be provided to the user is not present any more. Accordingly, the power distributing controller circuit 150 may reduce power consumption by cutting off the power from the first controller circuit (e.g., when a sensor is inactive, when a wireless module is disconnected, or when a lighting controller circuit remains unused, etc.).

According to an example, the power distributing controller circuit 150 may supply power to the second controller circuit, if receiving an address value of the second controller circuit, which is related to a request for starting a second service provided from the vehicle, after the power is supplied to the first controller circuit. The power distributing controller circuit 150 may individually control the first controller circuit and the second controller circuit (e.g., supplying power separately to both an infotainment controller circuit and a climate control controller circuit, or independently operating a navigation controller circuit and a charging controller circuit, etc.).

According to an example, the power distributing controller circuit 150 may supply power to the plurality of controller circuits 140 connected to the power distributing controller circuit 150, if a driving intention for the vehicle is determined as being present, in a third phase (e.g., powering all drivetrain controller circuits, safety systems, and user interface modules at ignition-on, etc.).

The power distributing controller circuit 150 may determine the driving intention for the vehicle (e.g., receiving a vehicle start request) as being present, if at least one of the pressing of a start button of the vehicle and/or a user input via the input interface 160 is recognized (e.g., pressing an ignition button, turning a key switch, selecting a “start driving” command on a touchscreen, or issuing a voice command, etc.).

Referring to FIG. 3C, the third phase may be a phase for supplying power if the user sends a request for a service related to driving. In the third phase, all switches 151 in the power distributing controller circuit 150 may be simultaneously turned on, and some switches 151 may be turned off in response to the request by the user. In this case, the service may be started again through only the input interface 160 such that the service provided from the vehicle is used again. However, in the third phase, the supply of the power may be maintained without turning off the switch of the controller circuit corresponding to the safety function during driving, if turning off the switch in response to the request by the user. For example, the power distributing controller circuit 150 may maintain the supply of the power for the second controller circuit, if receiving a request for terminating the service from the second controller circuit to control the electronic circuit related to the safety during the driving of the vehicle, after the power is supplied to the plurality of the controller circuits 140 (e.g., maintaining power to a braking controller circuit, a steering controller circuit, or an airbag control module even if a termination request is received, etc.).

According to an example, referring to FIG. 4, the service stack of the controller circuit 140 may add a component (third service) to provide a relevant service (220), if receiving power in response to the request for starting the service in an initial state 210 (e.g., enabling navigation, activating a media streaming module, launching a climate control function, or initiating a battery charging routine, etc.).

According to an example, referring to FIG. 5, the service stack of the controller circuit 140 may remove the component (third service) to provide a service (320), if receiving the request for terminating the service from the state in which the service is provided (310). In addition, the controller circuit 140 may report the idle state to the power distributing controller circuit 150 and may prepare for turning off the power, if the service stack is in the idle state (330) (e.g., when a video player stops streaming, when a navigation route ends, when a seat heating function is deactivated, or when a diagnostic session concludes, etc.).

According to an example, the input interface 160 may receive an input from the user. The input interface 160 may include at least one key or a button to receive the input from the user (e.g., a start/stop button, a climate control button, a volume control button, or a door unlock key, etc.).

According to an example, the input interface 160 may receive a signal, by manipulating the button by the user, or by sensing a touch input made by the user. In addition, the input interface 160 may receive the voice or the operation of the user via the camera or the microphone and may convert the voice or the operation into the input signal. To this end, a speech recognition technology or the motion recognition technology may be employed (e.g., gesture detection for window control, voice command for navigation, or face recognition for driver authentication, etc.).

According to an example, the input interface 160 may be implemented in the form of an external input interface. For example, the external input interface may include at least one of a touchpad, a touch pen, a keyboard, a mouse, and/or a controller circuit to receive a user input. For example, the controller circuit may include an inertial sensor and may generate an electrical signal by measuring an inertial value depending on the motion of a user hand (e.g., game-style steering controller circuits, handheld gesture remotes, or wearable wristband sensors, etc.).

According to an example, the input interface 160 may include a touchscreen configured to receive a touch input (or user touch input) made by the user and serving as a component the same as the output unit. The touchscreen may include any one of a capacitive touch manner, an infrared light sensing manner, a surface acoustic wave SAW manner, a piezoelectric manner, and a resistive film manner. However, the touchscreen is not limited thereto (e.g., OLED-based touch displays, flexible touch panels, or augmented-reality HUD touch overlays, etc.).

The input interface 160 may include a touch sensor to receive the user touch input applied to the touch screen. The touch sensor may convert a pressure, which is applied to a specific region of the input interface 160 or a change in capacitance generated in the specific region of the input interface 160 into an electrical input signal. The touch sensor may detect a touched position, a touch area, and a touch pressure. Accordingly, the input interface 160 may receive a user touch input through the touch sensor and may recognize the user touch input (e.g., pinch-to-zoom gestures, multi-finger swipes, or force-sensitive presses, etc.).

According to an example, the memory 170 may store an arbitrary type of information generated or determined by the power distributing controller circuit 150 and/or an arbitrary type of information received by the communication interface 120. For example, the memory 170 may store information related to vehicle power control. The memory 170 may be operated by the power distributing controller circuit 150. The memory 170 may store software programmed to allow the power distributing controller circuit 150 to perform a specific operation (e.g., logging service requests, saving diagnostic data, executing power distribution algorithms, or running predictive maintenance routines, etc.).

The memory 170 may include a storage medium of at least one of a flash memory type, a hard disk type, a multimedia card micro type, a card type memory (e.g., SD or XD memory), a random access memory (RAM), a static random access memory (SRAM), a read-only memory (ROM), an electrically erasable read-only memory (EPROM), a programmable read-only memory (PROM), a magnetic disk, an optical disk, and/or an optical disk. The vehicle power control apparatus 100 may operate in relation to a web storage to perform a storage function of the memory 170 over the Internet. The details of the memory described above are provided only for the illustrative purpose, but the present disclosure is not limited thereto (e.g., hybrid cloud storage, blockchain-based secure logging, or vehicle-to-cloud synchronization, etc.).

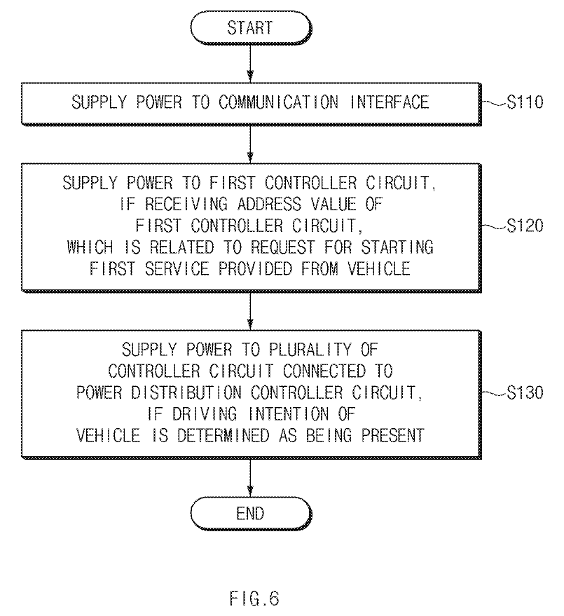

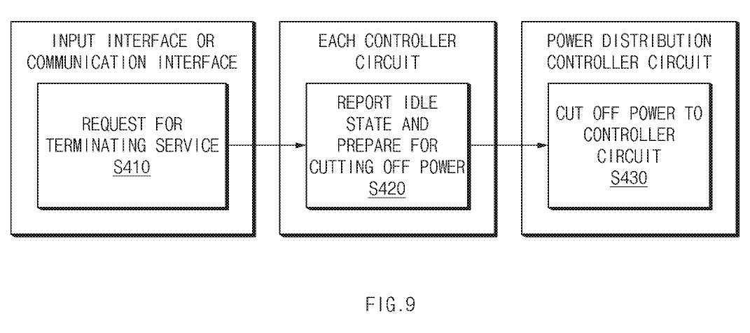

Hereinafter, a method for vehicle power control according to the present disclosure will be described in detail with reference to FIGS. 6-9. FIGS. 6 and 9 are flowcharts illustrating the method for the vehicle power control performed in the vehicle power control apparatus according to an example of the present disclosure (e.g., sequential service activation, staged power-on processes, or conditional safety overrides, etc.).

Hereinafter, it is assumed that the vehicle power control apparatus 100 of FIG. 1 performs processes of FIGS. 6, 7, 8 and 9. In addition, in the following description made with reference to FIGS. 6 or 9, it may be understood that operations described as being performed by an apparatus are controlled by the power distributing controller circuit 150 of the vehicle power control apparatus 100. In the following description made with reference to FIGS. 6, 7, 8 and 9, the details of the components in the vehicle power control apparatus 100 may be substituted with the description made with reference to FIGS. 5, 6, and 7.

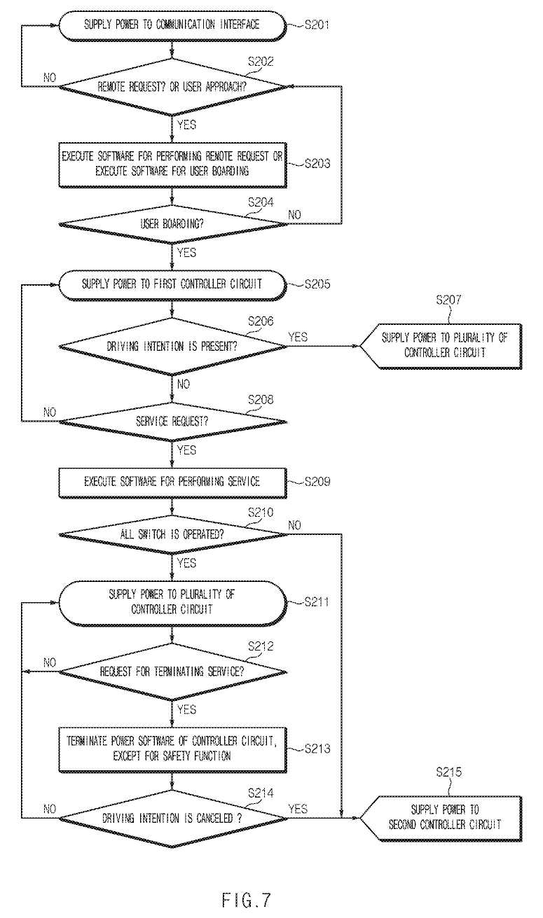

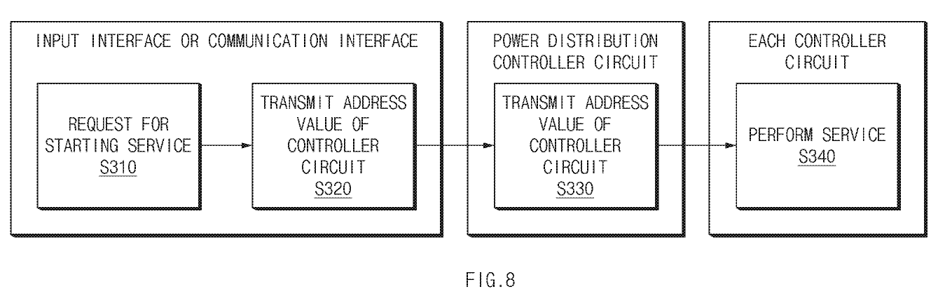

FIG. 6 shows an example of a method for vehicle power control performed in the vehicle power control apparatus according to an example of the present disclosure. FIG. 7 shows an example of a method for vehicle power control performed in a vehicle power control apparatus according to another example of the present disclosure. FIG. 8 shows an example of a procedure of requesting for starting a vehicle service and performing the vehicle service according to an example of the present disclosure. FIG. 9 shows an example of a procedure of requesting for the type of a vehicle service and stopping the vehicle service according to an example of the present disclosure (e.g., handling remote service activation, managing phased controller circuit transitions, or coordinating shutdown sequences for multiple electronic systems, etc.).

Referring to FIG. 6, the power distributing controller circuit 150 may supply power to the communication interface 120 (S110) (e.g., powering a telematics unit, a keyless entry receiver, or a cloud-connected modem, etc.).

According to an example, in the supplying of the power to the communication interface 120, a request for a service may not be received from a user of a vehicle, and the waiting for the request for the service may be performed (e.g., standing by for a remote cabin pre-conditioning command, a navigation update request, or a mobile app unlock signal, etc.).

According to an example, the power distributing controller circuit 150 may not supply the power to the plurality of controller circuits 140, before receiving the address value of the controller circuit 140, which is related to the request for starting the service, after the supplying of the power to the communication interface 120 (S110) (e.g., preventing unnecessary activation of infotainment, drivetrain, or climate controller circuits until explicitly requested, etc.).

According to an example, the power distributing controller circuit 150 may supply power to the input interface 160 provided in the vehicle, if the boarding of a user in a vehicle is detected (e.g., activating a steering wheel button module, enabling a biometric authentication pad, or powering a gesture recognition camera, etc.), after supplying power to the communication interface 120.

The power distributing controller circuit 150 may supply the power to the first controller circuit, if receiving the address value of the first controller circuit, which is related to the request for starting the first service provided from the vehicle (S120) (e.g., enabling the HVAC controller circuit for climate control, powering a navigation controller circuit, or starting a media playback controller circuit, etc.).

According to an example, the power distributing controller circuit 150 may cut off the power from the first controller circuit, if receiving the address value of the first controller circuit, which is related to the request for terminating the service, from the first controller circuit, after the power is supplied to the first controller circuit (S120) (e.g., shutting off a seat-heating controller circuit when deactivated, disabling a window control unit when operation stops, or powering down an auxiliary display, etc.).

According to an example, the power distributing controller circuit 150 may cut off the power from the first controller circuit, if receiving the report for the idle state of the first controller circuit, from the first controller circuit, after the power is supplied to the first controller circuit (S120). The idle state may mean that the service to be provided to the user is not present anymore (e.g., when a sensor is no longer active, when a communication link is closed, or when an audio system enters standby, etc.).

According to an example, the power distributing controller circuit 150 may supply the power to the second controller circuit, if receiving the address value of the second controller circuit, which is related to the request for starting the second service provided from the vehicle, after the power is supplied to the first controller circuit (S120). The first controller circuit and the second controller circuit may be individually controlled (e.g., independently controlling a charging controller circuit and an infotainment unit, etc.).

According to an example, the power distributing controller circuit 150 may supply the power to the first controller circuit, if receiving the address value of the first controller circuit, which is related to the request for starting the first service, via the communication interface 120 or the input interface 160 (e.g., address received via a smartphone app, a steering wheel button, or a voice-command system, etc.).

The power distributing controller circuit 150 may supply power to the plurality of controller circuits 140 connected to the power distributing controller circuit 150, if the driving intention of the vehicle (e.g., receiving a vehicle start request ) is determined as being present (S130) (e.g., powering all drivetrain, braking, steering, and lighting controller circuits when ignition is activated, etc.).

According to an example, the power distributing controller circuit 150 may maintain the supply of the power for the second controller circuit, if receiving a request for terminating the service from the second controller circuit to control the electronic circuit related to the safety during the driving of the vehicle, after the power is supplied to the plurality of the controller circuits 140 (S130) (e.g., continuing to power braking, steering, or airbag controller circuits despite termination requests, etc.).

According to an example, the power distributing controller circuit 150 may supply power to the plurality of controller circuits 140 in one-to-one correspondence via respective switches. For example, the power distributing controller circuit 150 may supply power in one-to-one correspondence to each of the plurality of controller circuits 140 by supplying power to the first controller circuit via the first switch, and supplying power to the second controller circuit via the second switch (e.g., supplying power separately to a transmission controller circuit, a braking controller circuit, or an infotainment controller circuit, etc.).

Referring to FIG. 7, the power distributing controller circuit 150 may supply power to the communication interface 120 (S201) (e.g., activating a telematics modem, a digital key receiver, or a wireless hotspot module, etc.).

It may be determined whether a remote request is received via the communication interface 120 or whether the user approaches (S202) (e.g., remote cabin pre-conditioning request, remote door unlock, or smartphone proximity detection, etc.).

The power distributing controller circuit 150 may execute software for performing the remote request or may execute software for user boarding (S203), if the remote request is received or the approach of the user is recognized via the communication interface 120 (S202; Yes) (e.g., running HVAC startup logic, enabling seat adjustment profiles, or launching charging session software, etc.).

The power distributing controller circuit 150 may recognize whether the user boards in the vehicle e.g., using seat pressure sensors, seatbelt latch sensors, or interior proximity sensors, etc.).

According to an example, the power distributing controller circuit 150 may receive the address value of the first controller circuit, which is related to the request for starting the first service provided from the vehicle, and may supply power to the first controller circuit (S205), if the boarding of the user is recognized (S204; Yes) (e.g., enabling infotainment for media playback, activating a navigation module, or starting a cabin climate controller circuit, etc.).

The power distributing controller circuit 150 may determine whether the driving intention for the vehicle is present (S206).

The power distributing controller circuit 150 may supply power to the plurality of controller circuits 140 connected to the power distributing controller circuit 150 (S207), if the driving intention of the vehicle is determined (e.g., a vehicle start request detected via powering drivetrain, safety systems, and dashboard controls, etc.) as being present (S206; Yes).

The power distributing controller circuit 150 may determine whether the request for starting the service is present (S208), if the driving intention for the vehicle is determined as being absent (S206; No) (e.g., user remains in accessory mode for infotainment, charging control, or communications without full driving mode, etc.).

The power distributing controller circuit 150 may execute the software to perform a service (S209), if the request for starting the service is determined as being present (S208; Yes) (e.g., launching a streaming service, enabling diagnostic checks, or running navigation updates, etc.).

The power distributing controller circuit 150 may determine whether all switches operate (S210) (e.g., whether all connected controller circuits such as braking, steering, and infotainment are powered, etc.).

The power distributing controller circuit 150 may receive the address value of the second controller circuit, which is related to the request for starting the second service provided from the vehicle, and may supply power to the second controller circuit (S215), if any switch of the power distributing controller circuit 150 does not operate (S210; No) (e.g., separately activating a navigation module while the infotainment controller circuit is already running, etc.).

The power distributing controller circuit 150 may supply power to the plurality of controller circuits 140 connected to the power distributing controller circuit 150 (S211), if all switches of the power distributing controller circuit 150 operate (S210; Yes) (e.g., powering all essential and non-essential controller circuits when transitioning into full driving mode, etc.).

The power distributing controller circuit 150 may determine whether the request for terminating the service is received (S212) (e.g., stopping media playback, disabling seat adjustment functions, or shutting down auxiliary lighting, etc.).

The power distributing controller circuit 150 may terminate power software of the controller circuits, except for a safety function (S213), if the request for terminating the service is received (S212; Yes) (e.g., maintaining power to braking or steering controller circuits but shutting off entertainment or auxiliary systems, etc.).

The power distributing controller circuit 150 may determine whether the driving intention for the vehicle (e.g., a vehicle start request) is canceled (S214). For example, the power distributing controller circuit 150 may determine the driving intention for the vehicle as being canceled, if movement of the vehicle is stopped or a start button of the vehicle is pressed once more (e.g., engine shutdown at destination, stopping after parking, or user pressing a stop/lock command on the dashboard, etc.).

The power distributing controller circuit 150 may supply the power to the second controller circuit, by receiving the address value of the second controller circuit, which is related to the request for starting the second service provided from the vehicle, if the driving intention (e.g., a vehicle start request) for the vehicle is canceled (S214; Yes) (e.g., continuing to allow charging control or infotainment operation after ignition-off, etc.).

Referring to FIG. 8, the vehicle power control apparatus 100 may receive the request for starting the service via the communication interface 120 or the input interface 160 (S310) (e.g., via a smartphone app, a steering wheel button, or a voice-command module, etc.).

The communication interface 120 or the input interface 160 may transmit an address value of the controller circuit 140 to the power distributing controller circuit 150 (S320) (e.g., transmitting the address of an HVAC controller circuit, a navigation unit, or a media controller circuit, etc.).

The power distributing controller circuit 150 may supply power to the controller circuit 140 using the address value of the controller circuit 140 (S330) (e.g., supplying power only to the requested controller circuit such as climate, infotainment, or charging without activating unrelated modules, etc.).

The controller circuit 140, which receives power, may perform the service to provide the service to the user (S340) (e.g., controlling HVAC for climate comfort, running a navigation function, enabling a charging routine, or activating entertainment features, etc.).

Referring to FIG. 9, the vehicle power control apparatus 100 may receive the request for terminating the service via the communication interface 120 or the input interface 160 and may transmit the request for terminating the service to the controller circuit 140 corresponding to the request for terminating the service (S410) (e.g., user pressing a stop button, sending a command from a smartphone app, or issuing a voice command such as “turn off air conditioning,” etc.).

The controller circuit 140, which receives the request for terminating the service, may report an idle state to the power distributing controller circuit 150, and prepare for cutting off power (S420) (e.g., infotainment system reporting shutdown, seat heater controller circuit reporting deactivation, or navigation module signaling end of trip, etc.).

The power distributing controller circuit 150 may cut off power to the controller circuit 140 (S430) (e.g., shutting down auxiliary displays, disconnecting sensors not in use, or deactivating a media playback module, etc.).

Hereinafter, the difference between a sleep mode of an existing electronic interface and the present disclosure will be described (e.g., laptops, smartphones, or tablets compared with vehicle controller circuits, etc.).

A general electronic interface includes one computing interface (CPU) and an auxiliary storage interface (memory) for assisting the computing interface. In this case, the sleep mode is implemented by supplying power only to the auxiliary storage interface, such that the minimum power is consumed in the transition of the sleep mode. However, according to the present disclosure, the sleep mode is implemented as the power distributing controller circuit turns on or off several dozens of controller circuits (each controller circuit independently includes a CPU) constituting the vehicle (e.g., engine control units, transmission controller circuits, infotainment units, or safety modules, etc.).

The general electronic interface includes a simple power system (operation or sleep), because considerations for safety and theft are not as significant as those of the electronic interfaces of the vehicle. In addition, in entering a sleep mode, many considerations may not be present, and a request for entering the sleep mode by a driver may be immediately executed. However, the electronic interfaces of the vehicle need to enter the sleep mode in consideration of safety and theft even if the request for entering the sleep mode is made by the driver (e.g., preventing unintended deactivation of security systems, alarms, or immobilizers, etc.). To overcome this, according to the concept of the power system, the electronic interfaces of the vehicle individually enter the sleep mode and maintain the minimal power consumption. However, issues related to dark current limitation are increasing, due to an increase in remote services and services in the engine-off (EV READY OFF) state (e.g., remote diagnostics, telematics connectivity, or over-the-air software updates, etc.). In particular, as the number of controller circuits rapidly increases, charging current to the 12 V and/or 24 V battery needs to be increased or continuously supplied even during driving. Even in the recall of the Integrated Charging Control Unit (ICCU), a problem is caused due to rapid discharge of the 12 V battery resulting from the interruption of charging from the high-voltage battery to the 12 V battery. Accordingly, it is difficult to resolve the battery discharge problem caused by the dark current with the existing power system (e.g., risk of battery failure, user inconvenience, or increased warranty claims, etc.).

Since the general electronic interface may stably receive power, the general electronic interface has relatively less strict requirements for entering a sleep mode. However, since the general electronic interface needs to effectively use limited power in the vehicle, the effective utilization of the sleep mode may be essential. To this end, conventionally, the controller circuits independently implement and utilize a sleep mode. However, as the number of controller circuits increases, the issue of dark current has become an item to be essentially checked in the vehicle development process (e.g., requiring validation testing, dark current audits, and optimized design of electronic control units, etc.).

To solve the problem, according to the present disclosure, the address value of the controller circuit related to a service is always transmitted to the power distributing controller circuit, at a time point to provide or terminate the vehicle service, thereby effectively using the power, freeing from implementing the sleep mode, and resolving even concerns about the dark current (e.g., reducing unnecessary standby drain, simplifying service management, or avoiding battery discharge scenarios, etc.).

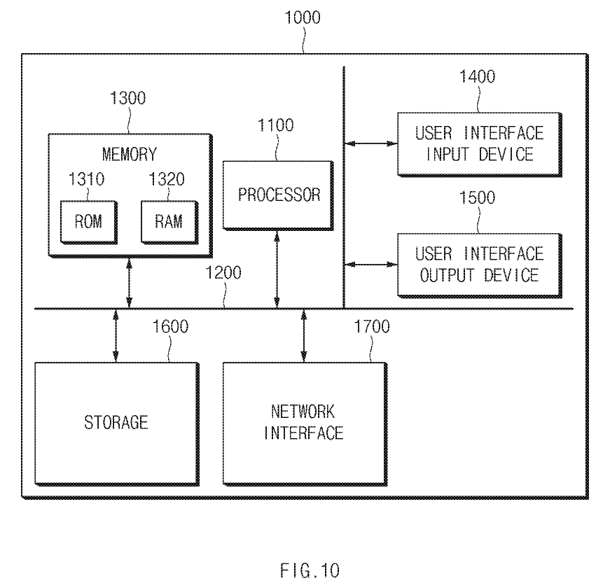

FIG. 10 shows an example of a computing system, according to an example of the present disclosure. The computing system may correspond to at least some components among components in the vehicle power control apparatus according to an example of the present disclosure.

Referring to FIG. 10, a computing system 1000 may include at least one controller circuit 1100, a memory 1300, a user interface input device 1400, a user interface output device 1500, a storage 1600, and a network interface 1700, which are connected with each other via a bus 1200 (e.g., PCIe bus, CAN bus, I²C bus, or Ethernet bus, etc.).

The controller circuit 1100 may be a central processing unit (CPU) or a semiconductor interface for processing instructions stored in the memory 1300 and/or the storage 1600 (e.g., a microcontroller circuit unit (MCU), a graphics processing unit (GPU), or a neural processing unit (NPU), etc.). Each of the memory 1300 and the storage 1600 may include various types of volatile or non-volatile storage media. For example, the memory 1300 may include a read only memory (ROM) and a random access memory (RAM) (e.g., DRAM, SRAM, or LPDDR memory used in embedded automotive systems, etc.).

Thus, the operations of the methods or algorithms described in connection with the examples disclosed in the present disclosure may be directly implemented with a hardware module, a software module, or a combination thereof, executed by the controller circuit 1100. The software module may reside on a storage medium (i.e., the memory 1300 and/or the storage 1600), such as a RAM, a flash memory, a ROM, an erasable and programmable ROM (EPROM), an electrically EPROM (EEPROM), a register, a hard disk, a removable disk, or a compact disc-ROM (CD-ROM) (e.g., SSDs, SD cards, Blu-ray discs, or cloud-synced storage, etc.).

The exemplary storage medium may be coupled to the controller circuit 1100. The controller circuit 1100 may read out information from the storage medium and may write information to the storage medium. Alternatively, the storage medium may be integrated with the controller circuit 1100. The controller circuit and storage medium may reside in an application specific integrated circuit (ASIC). The ASIC may reside in a user terminal (e.g., an automotive head unit, a telematics module, or a mobile interface, etc.). Alternatively, the controller circuit and storage medium (e.g., discrete CPU and flash storage mounted on a circuit board, etc.) may reside as separate components in a user terminal.

According to an example of the present disclosure, an apparatus for vehicle power control, the apparatus may include a battery provided in a vehicle, a communication interface provided in the vehicle, a plurality of controller circuits provided in the vehicle, to control a plurality of electronic circuits provided in the vehicle, respectively, and a power distributing controller circuit provided in the vehicle, to constantly receive power from the battery. The power distributing controller circuit may include supply the power to the communication interface, supply the power to a first controller circuit, if receiving an address value of the first controller circuit, which his related to a request for starting a first service provided from the vehicle, and supply power to the plurality of controller circuits connected to the power distributing controller circuit, based on determining a driving intention for the vehicle as being present.

According to an example, the power distributing controller circuit may supply the power to the communication interface, in a state in which a request for a service is not received from a user of the vehicle, and in a state of waiting for the request for the service.

According to an example, the power distributing controller circuit may not supply the power to the plurality of controller circuits, before the power is supplied to the communication interface to receive an address value of an controller circuit related to a request for starting a service.

According to an example, the power distributing controller circuit may cut off the power from the first controller circuit, if receiving an address value of the first controller circuit, which is related to a request for terminating a service, from the first controller circuit, after the power is supplied to the first controller circuit.

According to an example, the power distributing controller circuit may cut off the power from the first controller circuit, if receiving a report that the first controller circuit is in an idle state, from the first controller circuit, after the power is supplied to the first controller circuit.

According to an example, the power distributing controller circuit may supply the power to a second controller circuit, if receiving an address value of the second controller circuit, which is related to a request for starting a second service provided from the vehicle, after supplying the power to the first controller circuit, and the first controller circuit and the second controller circuit may be individually controlled.

According to an example, the power distributing controller circuit may maintain supply of the power to the second controller circuit, if receiving a request for terminating a service, from the second controller circuit to control an electronic circuit related to safety during driving of the vehicle, after supplying the power to the plurality of controller circuits.

According to an example, the power distributing controller circuit may supply the power to the plurality of controller circuits in one-to-one correspondence via switches.

According to an example, the apparatus may further include an input interface provided in the vehicle, and the power distributing controller circuit may supply the power to the input interface, if detecting boarding of a user in the vehicle, after supplying the power to the communication interface.

According to an example, the power distributing controller circuit may receive the address value of the first controller circuit, which is related to the request for starting the first service, via the communication interface or the input interface.

According to an example of the present disclosure, a method for vehicle power controller circuit in a power distributing controller circuit to control a communication interface provided in the vehicle, and a plurality of controller circuits to control a plurality of electronic circuits provided in the vehicle, respectively, may include supplying power to the communication interface, supplying the power to a first controller circuit, if receiving an address value of the first controller circuit, which is related to a request for starting a first service provided from the vehicle, and supplying the power to the plurality of controller circuits connected to the power distributing controller circuit, if determining a driving intention for the vehicle as being present.

According to an example, the power distributing controller circuit supplies the power to the communication interface, in a state in which a request for a service may not be received from a user of the vehicle, and in a state of waiting for the request for the service.

According to an example, the power may be not supplied to the plurality of controller circuits, before receiving an address value of an controller circuit related to a request for starting a service, after the power is supplied to the communication interface.

According to an example, the power may be cut off from the first controller circuit, if receiving an address value of the first controller circuit, which is related to a request for terminating a service, from the first controller circuit, after the power is supplied to the first controller circuit.

According to an example, the power may be cut off from the first controller circuit, if receiving a report that the first controller circuit is in an idle state, from the first controller circuit, after the power is supplied to the first controller circuit.

According to an example, the power may be supplied to a second controller circuit, if receiving an address value of the second controller circuit, which is related to a request for starting a second service provided from the vehicle, after supplying the power to the first controller circuit, and the first controller circuit and the second controller circuit may be individually controlled.

According to an example, supply of the power may be maintained to the second controller circuit, if receiving a request for terminating a service, from the second controller circuit to control an electronic circuit related to safety during driving of the vehicle, after supplying the power to the plurality of controller circuits.

According to an example, the power may be supplied to the plurality of controller circuits in one-to-one correspondence via switches, in the supplying of the power to the plurality of controller circuits.

According to an example, the power may be supplied to an input interface provided in the vehicle, if detecting boarding of a user in the vehicle, after supplying the power to the communication interface.

According to an example, the power may be supplied to the first controller circuit, if receiving the address value of the first controller circuit, which is related to the request for starting the first service, via the communication interface or the input interface, in the supplying of the power to the first controller circuit.

As described above, according to the present disclosure, the implementation of the sleep state (the lower power state) needs not be required, thereby reducing the number of developing processes of software and simplifying the power management concept.

According to the present disclosure, if the power distributing controller circuit merely notifies the controller circuits of the power-off state, the controller circuits may perform the free power-off preparation.

The vehicle power system, each controller circuit consumes power by booting (waking up) under specific conditions after entering a sleep state. However, according to the present disclosure, since power is not supplied to the controller circuits without permission from the power distributing controller circuit, no preparation for dark current is required after the vehicle is turned off. In addition, according to the present disclosure, when the request for performing the specific function is made in the start-off state, power may be supplied only to the controller circuits necessary for performing the relevant function, such that the power may be efficiently used.

According to the present disclosure, the power supply to each controller circuit may be independently controlled, and the power may be turned on or off without a request or agreement from the controller circuits. Accordingly, when the abnormal operation of the specific controller circuit is detected, the power distributing controller circuit may unilaterally turn the on or off power, thereby allowing a hardware reset such as a sudden acceleration prevention mode (the power of the controller circuit involved in vehicle acceleration is turned off).

Besides, a variety of effects directly or indirectly understood through the present disclosure may be provided.

The above description is merely an example of the technical idea of the present disclosure, and various modifications and modifications may be made by one skilled in the art without departing from the essential characteristic of the present disclosure.

Therefore, the examples of the present disclosure are provided to explain the spirit and scope of the present disclosure, but not to limit them, so that the spirit and scope of the present disclosure is not limited by the examples. The scope of the present disclosure should be construed on the basis of the accompanying claims, and all the technical ideas within the scope equivalent to the claims should be included in the scope of the present disclosure.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus of a vehicle, the apparatus comprising:
a battery;
a communication interface;
a plurality of controller circuits configured to control a plurality of respective electronic circuits of the vehicle; and
a power distributing controller circuit configured to:
receive power from the battery,
supply the power to the communication interface,
determine whether to supply the power to a first controller circuit of the plurality of controller circuits, based on receiving an address value of the first controller circuit, wherein the address value is related to a request for starting a first vehicle operation of the vehicle, and
based on a predicted driving operation for the vehicle, supply the power to the plurality of controller circuits.

2. The apparatus of claim 1, wherein the power distributing controller circuit is configured to supply the power to the communication interface while no request for a vehicle operation is received from a user of the vehicle, and wherein the communication interface is in a waiting state for the request.

3. The apparatus of claim 1, wherein the power distributing controller circuit is configured to disconnect the power supply to the plurality of controller circuits, before the power is supplied to the communication interface to receive an address value of a controller circuit of the plurality of controller circuits, wherein the controller circuit is related to a request for starting a vehicle operation.

4. The apparatus of claim 1, wherein the power distributing controller circuit is configured to:
after the power is supplied to the first controller circuit, determine whether to cut off the power from the first controller circuit, based on receiving, from the first controller circuit, a second address value of the first controller circuit, wherein the second address value is related to a request for terminating the first vehicle operation.

5. The apparatus of claim 1, wherein the power distributing controller circuit is configured to:
after the power is supplied to the first controller circuit, determine whether to cut off the power from the first controller circuit, based on receiving a report from the first controller circuit, wherein the report indicates that the first controller circuit is in an idle state.

6. The apparatus of claim 1, wherein the power distributing controller circuit is configured to:
after supplying the power to the first controller circuit, determine whether to supply the power to a second controller circuit of the plurality of controller circuits, based on receiving an address value of the second controller circuit, wherein the address value of the second controller circuit is related to a request for starting a second vehicle operation of the vehicle, and
wherein the power distributing controller circuit is configured to control power supply to each controller circuit of the plurality of controller circuits via a respective switch of the controller circuit.

7. The apparatus of claim 6, wherein the power distributing controller circuit is configured to:
after supplying the power to the plurality of controller circuits, determine whether to maintain supply of the power to the second controller circuit, based on receiving a request for terminating the second vehicle operation from the second controller circuit, wherein the second controller circuit is configured to control an electronic circuit of the vehicle related to safety during driving of the vehicle.

8. The apparatus of claim 1, wherein the power distributing controller circuit is configured to:
supply the power to the plurality of controller circuits in one-to-one correspondence via respective switches.

9. The apparatus of claim 1, further comprising:
an input interface,
wherein the power distributing controller circuit is configured to:
after supplying the power to the communication interface, based on detecting boarding of a user in the vehicle, determine whether to supply the power to the input interface.

10. The apparatus of claim 9, wherein the power distributing controller circuit is configured to:
receive, via the communication interface or the input interface, the address value of the first controller circuit.

11. A method performed by an apparatus of a vehicle, the method comprising:
controlling, by a power distributing controller circuit of the vehicle, a communication interface of the vehicle;
controlling, by a plurality of controller circuits of the vehicle, a plurality of respective electronic circuits of the vehicle;
supplying power to the communication interface;
determining whether to supply the power to a first controller circuit of the plurality of controller circuits, based on receiving an address value of the first controller circuit, wherein the address value is related to a request for starting a first vehicle operation of the vehicle; and
supplying the power to the plurality of controller circuits by connecting the power to the plurality of controller circuits to the power distributing controller circuit, based on a predicted driving operation for the vehicle.

12. The method of claim 11, wherein the supplying of the power to the communication interface comprises supplying the power to the communication interface while no request for a vehicle operation is received from a user of the vehicle, and wherein the communication interface is in a waiting state for the request.

13. The method of claim 11, further comprising:
after supplying the power to the communication interface, restricting the power from being supplied to the plurality of controller circuits, before receiving an address value of a controller circuit related to a request for starting a vehicle operation.

14. The method of claim 11, further comprising:
after supplying the power to the first controller circuit, determining whether to cut off the power from the first controller circuit, based on receiving a second address value of the first controller circuit from the first controller circuit, wherein the second address value is related to a request for terminating the first vehicle operation.

15. The method of claim 11, further comprising:
after supplying the power to the first controller circuit, determining whether to cut off the power from the first controller circuit, based on receiving a report from the first controller circuit, wherein the report indicates that the first controller circuit is in an idle state.

16. The method of claim 11, further comprising:
after supplying the power to the first controller circuit, determining whether to supply the power to a second controller circuit of the plurality of controller circuits, based on receiving an address value of the second controller circuit, wherein the address value of the second controller circuit is related to a request for starting a second vehicle operation of the vehicle, and
wherein supplying power to or cutting off power from the first controller circuit and the second controller circuit are performed independently of one another.

17. A vehicle comprising:
a battery;
a communication interface;
a plurality of controller circuits; and
a processor circuit configured to cause the vehicle to:
supply power from the battery to the communication interface in a waiting state in which a request for a vehicle operation is absent,
receive, via the communication interface, an address value of a first controller circuit of the plurality of controller circuits, the address value being associated with a request for starting a first vehicle operation,
supply, based on the received address value, power from the battery to the first controller circuit while restricting power supply to a second controller circuit of the plurality of controller circuits,
based on a predicted vehicle start request, supply power from the battery to the plurality of controller circuits, and
cut off power from the first controller circuit based on receiving from the first controller circuit at least one of:
a request for terminating the first vehicle operation, or
a report of an idle state.

18. The vehicle of claim 17, wherein the processor circuit is configured to cause the vehicle to maintain power supply to a controller circuit associated with a safety-related service during driving of the vehicle, regardless of a received request to terminate the safety-related service.

19. The vehicle of claim 17, wherein the processor circuit is configured to cause the vehicle to, based on detecting an abnormal operation of at least one of the plurality of controller circuits, cut off power to the at least one of the plurality of controller circuits to perform a hardware reset.

20. The vehicle of claim 17, wherein the processor circuit is configured to cause the vehicle to supply power from the battery based on detecting an authenticated key in the vehicle.
